(19) United States
(12) Patent Application Publication
(10) Pub. No.: US 2002/0113811 A1
(43) Pub. Date: Aug. 22, 2002

(54) Information system and method for creation thereof

(76) Inventor: Mitchell P. Davis, Washington, DC (US)

Correspondence Address: Richard C. Litman, LITMAN LAW OFFICES, LTD., P.O. Box 15035, Arlington, VA, 22215, US

(21) Appl. No.: 09/789,579

(22) Filed: Feb. 22, 2001

(51) Int. Cl. G06F 7/00

(52) U.S. Cl. 345/710

(57) ABSTRACT

A method for creating a compilation (book) from existing content on a Web site, as well as an information system which includes both a bound book, and a searchable format of the bound book. The searchable format of the bound book is located on a Web site identified by a Universal Resource Locator (URL) printed on the spine of the bound book. The method includes selecting a button on a Web site to create a book, searching that Web site to find the content, inserting a title and an introduction, and choosing a format and revenue model for the distribution of the book. A URL printed on the spine of the bound book corresponds to the title of the book, assuming that the bound book format option was selected, and identifies a Web site having a searchable format of the bound book and selling the bound book.

### BACKGROUND OF THE INVENTION

1. Field of the Invention

The present invention relates to a method for creating a compilation from existing content on a Web site, as well as an information system which includes both a bound copy, i.e. a bound book, and a searchable format of the bound book. A searchable format of the bound book is located on a Web site identified by a Universal Resource Locator printed on the spine of the bound book.

2. Description of the Related Art

U.S. Pat. No. 5,624,265, issued on Apr. 29, 1997 to Peter M. Redford et al., teaches a remote control for accessing interactive media. The remote control can be located physically in a book.

U.S. Pat. No. 5,793,972, issued on Aug. 11, 1998 to Terrence Shane, teaches a direct mail system assigning a unique URL to each recipient. When the recipient goes to the Web page, the system can respond with unique information.

U.S. Pat. No. 5,899,700, issued on May 4, 1999 to John Williams et al., teaches multimedia control based on signals from codes embedded in printed material.

U.S. Pat. No. 5,957,697, issued on Sep. 28, 1999 to Jerry Iggulden et al., teaches an electronic virtual book accessing a remote server based on a password in a printed book.

World Intellectual Property Organization Patent 98/06055, published on Feb. 12, 1998, teaches a bar code reader that reads a URL and a Web browser that connects to a Web page identified by that URL.

None of the above inventions and patents, taken either singularly or in combination, is seen to describe the instant invention as claimed. Thus a method and system for providing access to information solving the aforementioned problems is desired.

### SUMMARY OF THE INVENTION

The present invention relates to a method for creating a compilation from existing content on a Web site, as well as an information system which includes both a bound copy, i.e. a bound book, and a searchable format of the bound book. The searchable format of the bound book is located on a Web site identified by a Universal Resource Locator (URL) printed on the spine of the bound book. A book is defined herein as any type of compilation, which may be available in several formats, as noted below. A bound book is specifically a book or compilation that is in printed form and placed in a binder or bound in some manner.

The method includes selecting a button on a Web site to create a book, searching that Web site to find the content to put in the book, inserting a title and an introduction into the book, choosing a format in which the book will be distributed, and choosing a revenue model for the distribution of the book.

The selection of a button on a Web site is accomplished merely by clicking on a clickable field which offers the opportunity for the creation of a book. The button, or clickable field, may say something such as “Click here to create a XeroBook. There is no cost until you approve your book for publication.” When the user's cursor is positioned over the button, a display box opens in the upper corner of the screen that may read:

What is a XeroBook? A XeroBook is your personal copy of the pages from this Web site that you create, with your introduction and title, and make available in bound book form, custom Web site, downloadable database, or as a facsimile. If you select bound book form, your title will be printed on the spine of the book and you can register your title as a URL. Once you have created your XeroBook, you can earn money every time a copy of your book is sold (based on your selected revenue model). Your XeroBook can be available for sale at a site with the same name as your title. We can register a copyright for you.

Searching the Web site to find the content to put in the book may include searching using a known search engine, manually searching, or browsing a Web site. It is noted that searching can occur either before or after the selection of the clickable field which offers the opportunity for the creation of a book. The invention contemplates either prompting a user of a Web site to create a book immediately upon entry into the Web site or after that user has searched for a desired topic.

Inserting a title and an introduction to the book may include entering these, if the user so chooses, into an online form. Alternatively, the user may have previously written them, particularly the longer introduction, and can upload them from a location on which they are stored, e.g. a hard drive.

Choosing a format for the book and a revenue model determine the distribution and the remuneration for the book. Each of these choices may be presented to the user in an online form, either the same or different from that for other entries (i.e. introduction and title). The online form will preferably present a series of options for book format and revenue model. These options for format will include bound book, custom Web site, downloadable database, or facsimile.

The options for revenue model will include giving the book away for free (the user who created the book pays for each copy given away), charging a fee for the book, or charging the fee plus a royalty for the book (royalty paid to the creator of book).

If the user has selected the bound book it is printed and bound into a book having a spine. A URL printed on the spine of the bound book corresponds to the title of the book, assuming that the URL was available, and identifies a Web site having a searchable format of the bound book and selling the bound book.

Accordingly, it is a principal object of the invention to provide a method for Web site users to create a book using the content of the Web site.

It is another object of the invention to provide a method allowing the user to insert a title and introduction into the book.

It is a further object of the invention to provide a method allowing the user to designate the format and the revenue model for the book.

Still another object of the invention is to provide an information system linking a bound book to a Web site.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a schematic representation of a method for allowing a user to create a book.

FIG. 2 is a schematic representation of a method of a user to create a book.

FIG. 3 is a representation of exemplary Web pages facilitating the instant method.

FIG. 4 is an information system including a bound book and associated Web page.

Similar reference characters denote corresponding features consistently throughout the attached drawings.

### DETAILED DESCRIPTION OF THE PREFERRED EMBODIMENTS

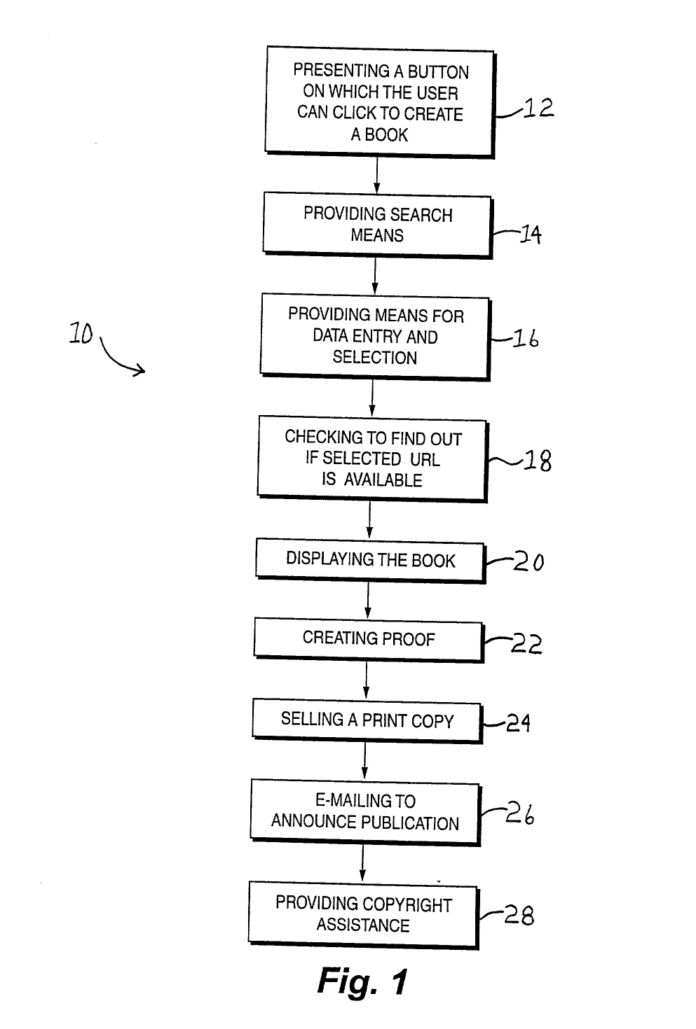

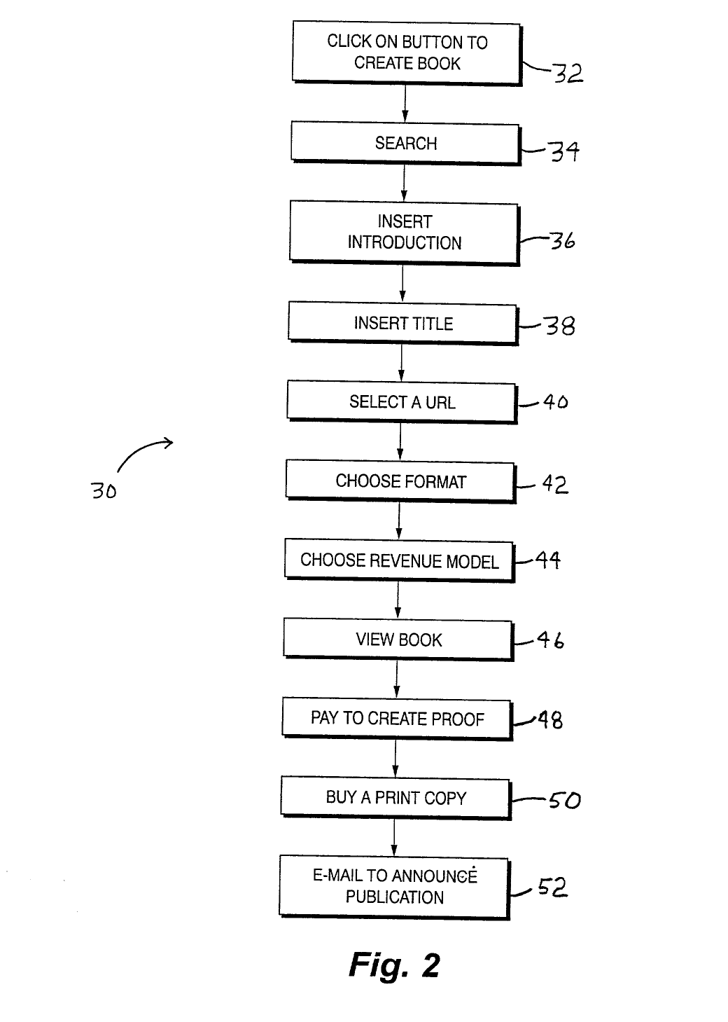

The method of the present invention, which relates to the creation of a compilation from existing content on a Web site, is described with reference to FIGS. 1 and 2.

FIG. 1 shows a method of allowing a user to create a book 10. After a user enters a Web site, the site may present a button, i.e. a clickable field, 12 on which the user can click to create a book, i.e. a compilation. If the user elects to create a book, the Web site then provides a search means 14. It is preferred that the search means is a typical search engine. However, manual searching or browsing the various Web pages (and marking those desired to enter into the book) would constitute search means contemplated by the present invention.

It is noted that the step of presenting a button 12 and that of providing a search means 14 could be reversed, i.e. the user could search before deciding to create a book. Further, the step of presenting a button 12 could be offered both before and after the step of providing a search means 14 to allow a user who chose not to create a book initially to change their mind after searching.

The Web site will then provide means for data entry and selection 16, which includes allowing the user to enter an introduction and a title, to select a Universal Resource Locator (URL), to select a format in which the book will be presented, and to select a revenue model for the distribution of the book. The user selects the format from the options of bound book form, custom Web site, downloadable database, a facsimile, or any other type of format for an information source.

If the user selects the bound book format, the selected URL (which is checked for registration availability 18) is printed on the spine of the book. This URL (generally the title of the book) will identify a Web site on which a searchable form of the book is located and which offers the book for sale.

Revenue models which may be selected include giving the book away for free (the user who created the book pays for each copy given away), charging a fee for the book, or charging the fee plus a royalty for the book (royalty paid to the creator of book).

After the user has created the book and selected the distribution model, the book is displayed 20, a proof is created 22, and the user is sold a print copy 24. Finally, the Web site on which the user has created the book will assist in publicity by electronic mailing to announce the publication of the book 26 and provide copyright assistance 28.

FIG. 2 shows the steps of a user to prepare a book 30 according to the present method. After entering a Web site, the user clicks on a button to choose to create a book 32. The user then searches (using a search engine, manually, or by browsing Web pages) to find the content desired for inclusion into the book 34. It is noted that the order of steps 32 and 34 can be reversed or varied, as discussed above with respect to steps 12 and 14.

The user then inserts an introduction 36 and a title 38. These insertions may simply be typed in response to Web-based queries or, especially in the case of the longer introduction, instructions as to where to find previously-created insertions into the book on a hard drive or other storage means. The user may then select a URL (generally the title of the book) 40, and choose a format 42 and a revenue model 44 for the distribution of the book.

The user then views the book 46, pays to create a proof copy 48, and, if acceptable, buys a print copy 50. The user may then send electronic mail to announce the availability of the book 52.

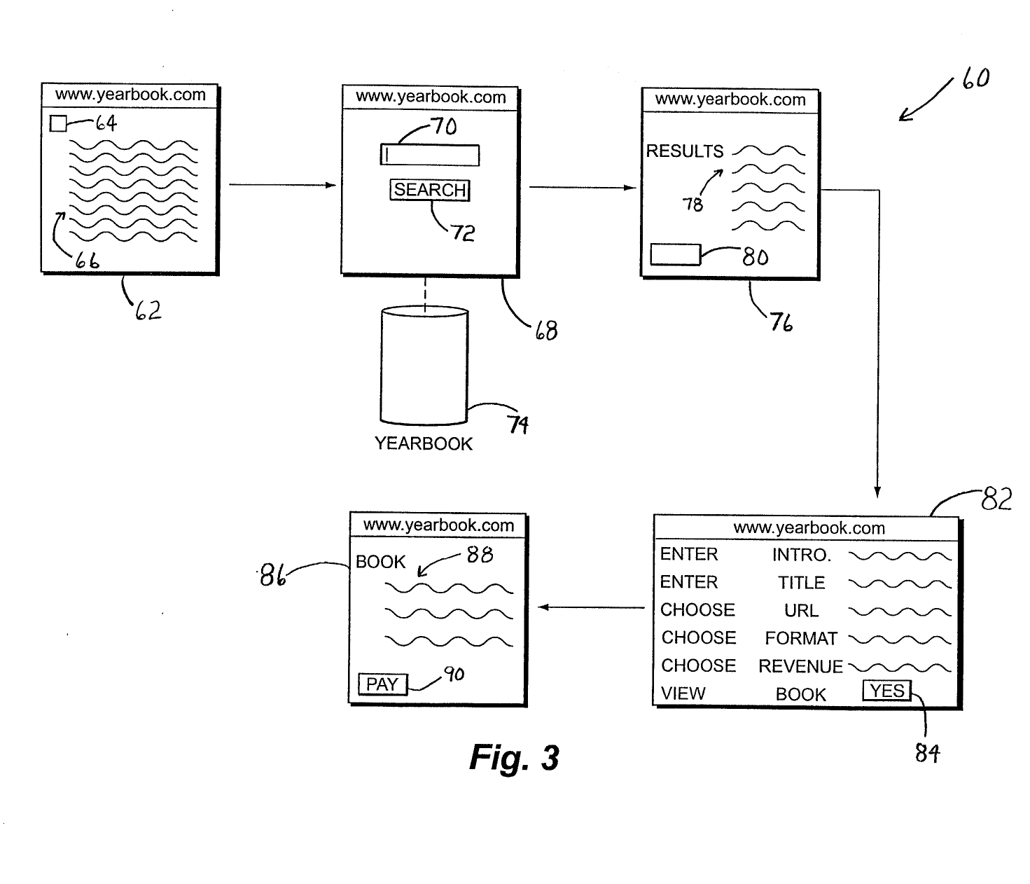

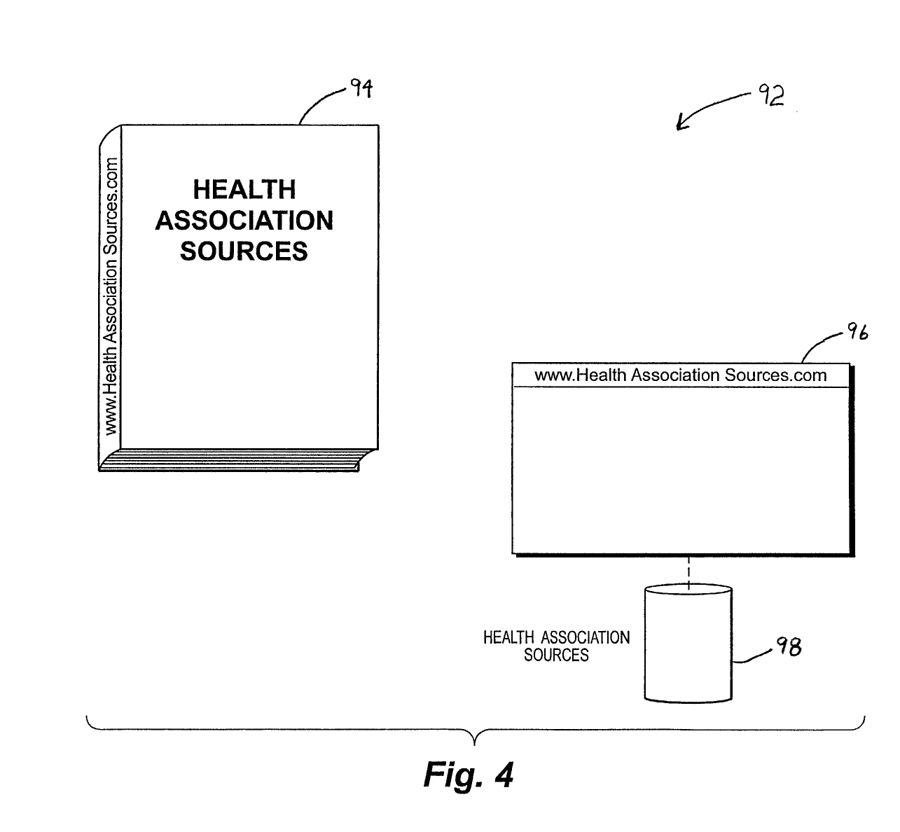

Exemplary Web pages 60 which allow a user to create a book using the instant method are seen in FIG. 3. The initial page 62 which a user may see is one offering to allow the user to create a book. This page 62 may include a button or clickable field 64 giving the user the option to create a book, as well as other text 66. The search page 68 is presented next (it is noted, as above, that the order of the search and the selection to create a book can be reversed or varied). This page generally includes a box 70 for entering a search field and a button 72 for directing the search to begin, and causing a search of the entire database 74. In the example shown in FIGS. 3 and 4, this is the entire yearbook.

The results page 76 presents the results 78 from the search and presents a button 80 which allows the user to select to utilize the search results in the book. It is noted that button 80 may present the option to create a book assuming that button 64 was not earlier selected, i.e. if the user originally did not chose to create a book. As discussed above, a user who has previously chosen not to create a book is given a second chance to do so (after seeing the search). If the user clicks on button 80, indicating acceptance of the search results for inclusion into the book, the user is presented with an entry and selection Web page 82.

The page 82 may include fields for creating the book. These fields include those for entering an introduction (or indicating where on a hard drive it is stored) and a title. It is noted that a user may not wish to enter an introduction and there will be an option for not entering one, e.g. leaving the field blank. The user also may choose a URL, usually based on the title, and have it registered if it is available.

The user then chooses a format for the book, i.e. bound book, custom Web site, downloadable database, or facsimile. Finally, the user chooses a revenue model, giving the book away for free (the user who created the book pays for each copy given away), charging a fee for the book, or charging the fee plus a royalty for the book (royalty paid to the creator of book). The selection of the format and revenue model are generally referred to as the control, or establishment, of the distribution of the book.

It is noted that variations of the entry and selection process exemplified by page 82 are well within the scope of the present invention. For example, multiple pages may be used for these entries. Additionally, multiple choice options (e.g. the user may click on one of several boxes to indicate a choice) may be given for format and revenue selections. Regardless of the presentation to the user, the user can indicate the desire to view the book after all entries and selections have been made. The example in FIG. 3 shows a button 84 to indicate the desire to view the book.

The page 86 on which the book is viewed shows the book 88 and presents a button 90 on which the user can click to pay for having a proof copy created. Payment information is taken and processed and a proof copy is created. After approval by the user, the user is given the option of purchasing a print copy and e-mails may be sent to announce the publication (it is noted that traditional mailings could be used to accomplish the publicity).

FIG. 4 shows the information system 92 which is created by the instant method and Web pages shown in FIGS. 1-3. The book 94 that is created (in the example in FIG. 4, it is a bound book) includes a URL on its spine. This URL, which is based on the title of the book, identifies a Web page 96. The page 96 allows for purchasing copies of the book and includes a searchable database 98 including information in the book 94. It is noted that the database 98 may be information based in real time and more current than the book 94.

By way of example (utilizing the showings of FIGS. 3 and 4), a user may enter a Web site yearbook.com, which may list 1800 experts in different fields. The user may then search the yearbook database 74, which would include listings of the 1800 aforementioned listings, for health professionals. This search would result in 300 experts in the health field.

The user may then choose to comment on these health professionals in some way, i.e. write an introduction. The user will then have the book created, as previously described. The book, which will include the 300 listings of experts in the health field, may be called Health Association Sources and the associated Web site will be www.healthassociationsources.com (which will be printed on the spine of the book if it is bound). The Web site will allow purchase of the hard copy of the book and allow searching of the Health Association Sources database 98, e.g. for those health experts located in a certain geographical area. It is noted that the database 98 can be the book in searchable format or it can be an updated version, e.g. contain new addresses. It is seen that the created database 98 is a subset of the original database 74.

It is to be understood that the present invention is not limited to the embodiments described above, but encompasses any and all embodiments within the scope of the following claims.

I claim:

1. A method of allowing a user to use content from a Web site to create a book comprising:
presenting a user with a button on a Web site screen on which the user can click to create a book;
providing a search means for the user to locate the desired content for publication into the book; and
providing entry and selection means so that the user can create and control the distribution of the book.

2. The method of claim 1 further including publishing the book into a bound copy having a spine.

3. The method of claim 2 wherein said publishing includes printing the Universal Resource Locator on the spine of the book.

4. The method of claim 1 wherein providing a search means includes providing a search engine.

5. The method of claim 1 further comprising providing assistance with copyrighting the book.

6. The method of claim 1, wherein said providing entry and selection means includes:
providing means for the user to insert an introduction into the book;
providing means for the user to insert a title into the book;
allowing the user to choose a Universal Resource Locator for the book;
allowing the user to choose the format in which the book is available; and
allowing the user to choose the revenue model for the distribution of the book.

7. The method of claim 1 wherein further including checking if the Universal Resource Locator is available.

8. A method of using the content from a Web site to create a book comprising:
selecting a button on a Web site screen which allows the creation of a book;
searching for the desired content for publication into the book; and
entering and selecting information to create and control distribution of the book.

9. The method of claim 8 including submitting an order for the book to be published as a bound copy having a spine.

10. The method of claim 9 wherein said submitting includes requesting that the Universal Resource Locator be printed on the spine of the book.

11. The method of claim 8 wherein searching includes searching with a search engine.

12. The method of claim 8 wherein searching includes manually selecting a desired portion and selecting to include that portion into the book.

13. The method of claim 8 further comprising copyrighting the book.

14. The method of claim 8 wherein said entering and selecting includes:
inserting an introduction into the book;
selecting a title for the book;
selecting a Universal Resource Locator for the book;
choosing a format in which the book is available; and
choosing a revenue model for the distribution of the book.

15. The method of claim 8 wherein said entering and selecting includes one or more of:
inserting an introduction into the book;
selecting a title for the book;
selecting a Universal Resource Locator for the book;
choosing a format in which the book is available; and
choosing a revenue model for the distribution of the book.

16. An information system comprising, a bound copy of a book having a compilation of information within a field, said book having a spine including a Universal Resource Locator, said Universal Resource Locator being related to the field of information.

17. The information system of claim 14 wherein said Universal Resource Locator directs a user to a Web site concerning said field of information.

18. The information system of claim 14 further comprising a Web site identified by said Universal Resource Locator and including a searchable database, which is a current version of said listing included in said book.

19. The information system of claim 14 further comprising a Web site identified by said Universal Resource Locator and including information related to the information in said book.
